(19) United States
(12) Patent Application Publication
(10) Pub. No.: US 2007/0032361 A1
(43) Pub. Date: Feb. 8, 2007

(54) Multiple stage web material processor

(76) Inventor: Alan R. Venuti, Elkton, FL (US)

Correspondence Address: Fulbright & Jaworski LLP;John F. Klos, Suite 2100, 80 South Eighth Street, Minneapolis, MN, 55402, US

(21) Appl. No.: 11/197,884

(22) Filed: Aug. 5, 2005

(51) Int. Cl. B31C 11/04

(52) U.S. Cl. 493/276

(57) ABSTRACT

A multiple stage web processor including a tensioning stage and a gluing stage. The tensioning stage includes an air bag which generates a normal force applied against the web material. Web material tension may be altered with a change in air bag pressure. The gluing stage includes an adhesive applicator and provides an adhesive along a portion of the web material surface and also applies a second normal force and tension to the web material. Together the tensioning stage and the gluing stage provide a controlled tension to the web material as the web material is drawn through the apparatus and wrapped around a tube-forming mandrel. The web processor may include a lubrication stage applying a lubricant to the web material surface. A method of forming a core from a web material with a web processor is disclosed.

### TECHNICAL FIELD

The present invention relates to spiral wound tubes. More particularly, this invention relates to ply handling equipment, particularly for high speed spiral wound tubes, and to methods and apparatuses for winding such tubes.

### BACKGROUND OF THE INVENTION

Spiral wound paper tubes are well known. Disposable sheet goods such as bath tissue, paper towels, gift wrap, aluminum foil and the like, are often sold in the form of a roll supported by a tubular paperboard core. Because of the strength required in the paperboard core during the process of winding the disposable sheet goods onto the core, the core has normally been formed of at least two radially superposed layers, which in turn, are formed from separate spirally wound paperboard plies. Each of the spirally wound paperboard plies forms a helical seam which extends in the axial direction along the paperboard tube and which results from abutment of the opposed longitudinally extending edges of the ply along the length of the tube.

The multiple ply paperboard tube making process is often conducted by winding the innermost paperboard layer onto a stationary mandrel while simultaneously winding one or more exterior paperboard plies successively radially outwardly from the exterior of the first ply. An adhesive coating is applied to the exterior face of the inside paperboard ply and/or to the interior face of the adjacent exterior paperboard ply. As a result, radially adjacent plies forming separate layers adhere strongly to each other so that the tube can have considerable strength. Although each of the spirally wound layers includes a continuous helical seam, the composite tube formed from several layers does not readily unravel because the seams in adjacent paperboard layers are offset radially from each other as mentioned above, and because of the substantial surface bonding between adjacent tube layers.

The adhesive coating may be applied to a ply utilizing known adhesive applicators, such as rotating doctor and kiss rolls conveying adhesive contained within a tank. Such applicators tend to be relatively bulky and require routine maintenance.

Particularly in those cases where the paperboard tube is used as a core support for a disposable sheet material such as paper towels, toilet tissue, or the like, it is highly desirable to minimize the cost of the paperboard core. This has been achieved in typical commercial practice by minimizing the number of layers of paperboard used to form the core and by minimizing the cost associated with the paperboard forming each of the layers. Accordingly, commercially available cores have often been formed from only two layers and each layer is formed from a relatively inexpensive and weak paperboard, typically of relatively low density and having a high content of recycled material.

There is a limit to the minimum strength of paperboards that can be used to manufacture paperboard cores. Thus, the cores cannot be made from materials which are so thin and/or weak that they will not form a self-supporting structure upon being wound into helical form because the tube structure must provide support to the sheet material which is wound onto the core. Similarly, the paperboard tube must be formed from at least one layer, and in commercial practice, at least two paperboard layers have typically been used because of the substantial strength resulting from the bonding and proper alignment of the multiple layers.

Various attempts have been made to make paperboard tubes from a single layer of paperboard by forming an overlap joint along the helical seam. A tube comprising a single ply of web material can require less web material and less adhesive to form the tube. Attempts have been made to overlap one edge of the ply onto the top of the other edge of the ply as the ply is wound onto the mandrel. It is often difficult to properly bond the overlapped joint. Improper bonding often results in tube having a single continuous helical seam which is apt to unravel.

It has also been found in practice that a uniform and properly bonded overlapped joint is particularly difficult to achieve when attempts are made to form single ply tubes from paperboard plies. When an overlapped joint is formed, substantial tension must be applied to the tube-forming ply during the spiral winding process. This is necessary so that the overlapping edge will make substantial and uniform contact along the length of the tube. At the same time, the primary portion of the paperboard layer must make substantial contact with the supporting mandrel to avoid formation of an uneven interior surface. If either of these conditions are not met, the paperboard tube can have an uneven, wrinkled appearance and/or will not be uniformly bonded along the overlapping joint.

A need remains for a paper web material processor for use particularly in single-ply tube forming operations which provides consistent and controllable tension to the web material being drawn onto the mandrel. Preferably the web tension may be adjusted or controlled depending upon the application requirements.

### SUMMARY

The present invention is directed towards a spiral wound tube. Spiral wound tubes comprising a single ply of paper web material may be formed by the method and apparatus herein described. In one embodiment, the method comprises steps of providing a mandrel, a single ply of web material, and a web processor. An adhesive binding agent is applied to a portion of the web material as it is drawn through the web processor according to the invention. The web processor provides a consistent and controllable tension to the web material as it is drawn onto the mandrel during the tube forming operation.

The web processor may include multiple stages including a tensioning stage and a gluing stage. The tensioning stage includes an air bag expanding in response to pressurized air to generate a normal force applied against the web material. During operation, web material tension may be altered with a change in air pressure communicated to the air bag. The gluing stage includes an adhesive applicator providing an adhesive along a portion of the web material surface. The gluing stage applies a second normal force to the web material. Together the tensioning stage and said gluing stage providing a controlled tension to the web material as the web material is drawn through the apparatus and wrapped around a tube-forming mandrel. Tension provided by the tensioning stage may be substantially greater than tension provided by the gluing stage.

The web processor may optionally include a lubrication stage applying a lubricant to the web material surface. A variety of different lubricants could be applied.

The present invention is also directed towards a method of forming a core from a web material with a web processor. Such a method may include the steps of withdrawing a web material from a supply roll, passing the web of material through a tensioning stage having an air bag providing a normal force to a surface of the web material, passing the web material through an adhesive stage having an adhesive applicator applying an adhesive to a portion of the web material, and winding the web material upon a mandrel whereby the adhesive-applied portion of web material overlaps another portion of the web material to form a core. Such method is particularly suited for single-ply core forming operations. However, the methods and apparatus disclosed herein may be adaptable to multi-ply paperboard core forming operations as well.

Accordingly, it is an object of the present invention to provide an improved spiral wound tube and method of making same. Other objects and advantages will appear hereinafter.

### BRIEF DESCRIPTION OF THE DRAWINGS

The present invention will be more fully understood and further advantages will become apparent when reference is made to the following detailed description of the invention and the accompanying drawings wherein like numerals represent like elements, and in which:

FIG. 1 representatively shows a top view of an example of a core winding station utilizing a web processor according to the present invention;

FIG. 2 is a perspective view of an embodiment of a web processor according to the present invention;

FIGS. 3 and 4 illustrate an embodiment of a web processor shown in partially disassembled perspective view;

FIG. 5 represents a side elevational view of the web processor of FIGS. 1 and 2.

### DETAILED DESCRIPTION

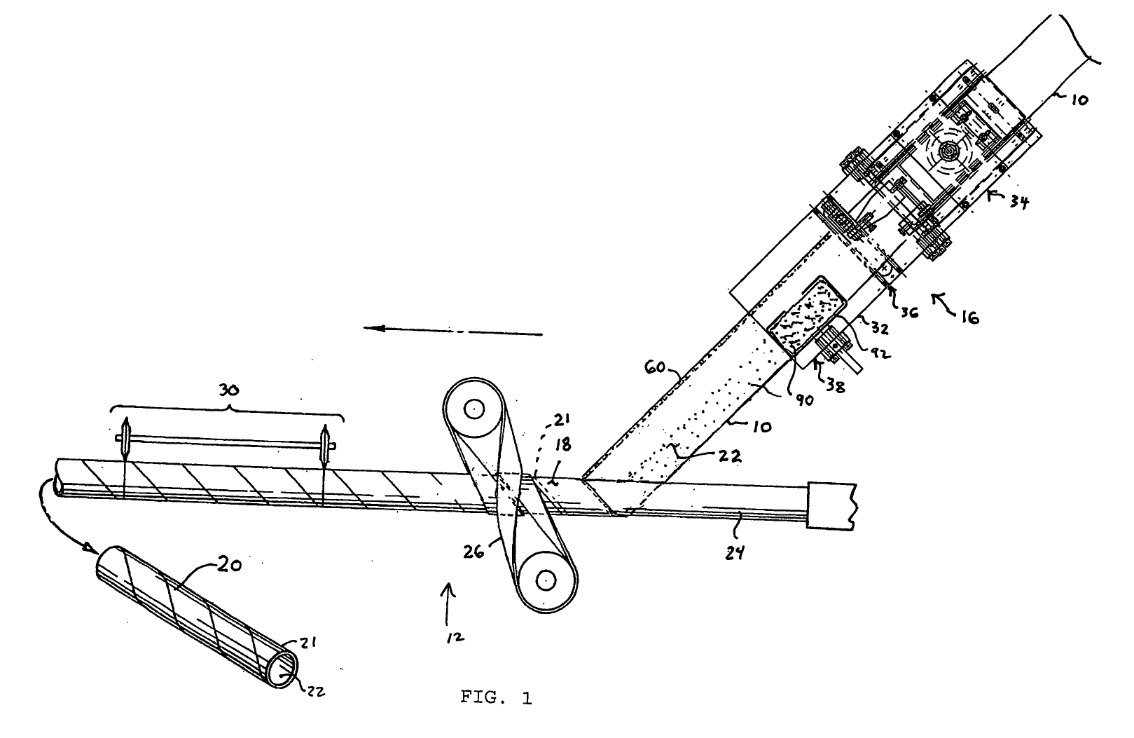

As illustrated in FIG. 1, web material 10 is provided to a winding apparatus 12 from a parent or supply roll (not shown). Prior to being introduced to winding apparatus 12, web material 10 passes through a web processor 16. The length of the web material 10 is substantially greater than the width or thickness of the material. The web material 10 has a first surface 18 that forms the outer surface of the wound tube 20 and a second surface 22 that forms the inner surface of the wound tube 20. An overlap region 21 is defined adjacent to a lateral edge of the web material 10. As described in more detail herein, an adhesive is applied within the overlap region 21 during the tube forming process. Depending on the particular operating environment, the adhesive may be supplied on either the outer surface 18 or inner surface 22 of wound tube 20.

FIG. 1 schematically illustrates one preferred process for forming a continuous paperboard tube from a continuous web 10. Generally, the web 10 passes through web processor 16 which applies a layer of adhesive to overlap region 21 on second surface 22. Web 10 is spirally wound onto a mandrel 24 to form an elongated tube 20. A winding unit including an endless belt 26 rotates tube 20 as it is formed onto mandrel 24 and thus pulls the web material 10 onto the mandrel 24 as is well known in the art. The winding unit employed can be any known to those skilled in the art to be suitable for winding a web material about a mandrel. Tube 20 is cut into shorter tubes of a desired length at a cutting station 30.

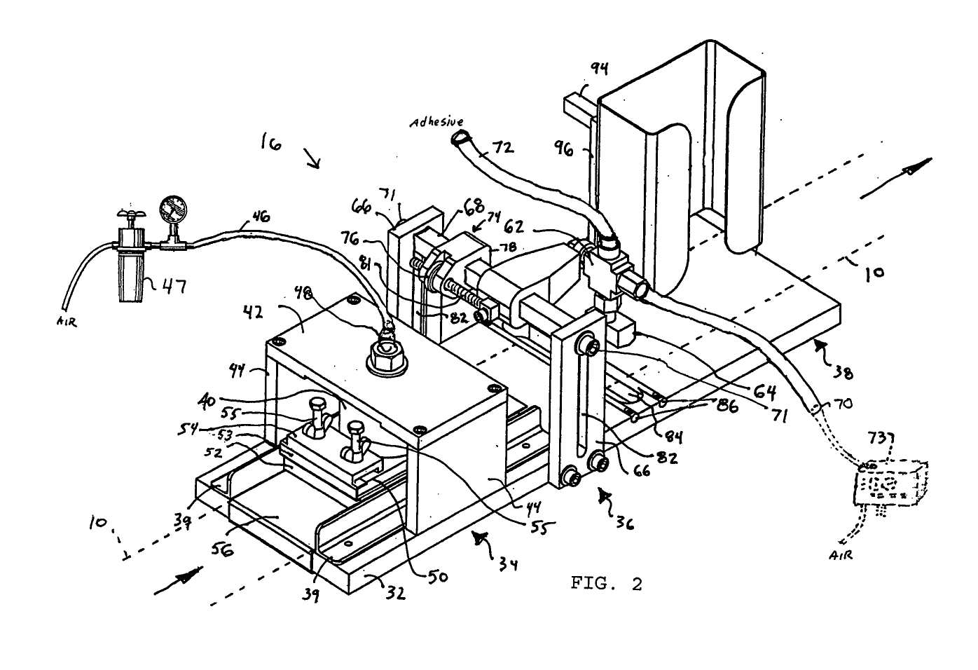

Referring particularly to FIG. 2, in an embodiment of the invention the web material 10 is routed through multistage web processor 16. Web processor 16 includes a base 32, a tensioning stage 34, an adhesive stage 36, and an optional lubricant stage 38. As described in detail hereinafter, together the tensioning and adhesive stages provide a controlled amount of tension to the web 10 being drawn through the web processor 16.

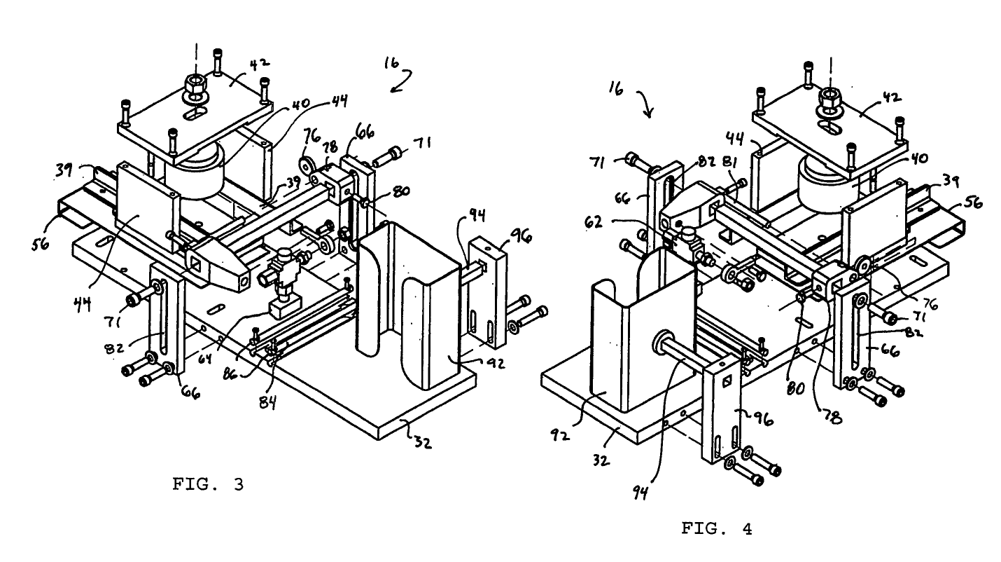

In the illustrated embodiment of FIGS. 1-5, base 32 is a generally planar element to which components of tensioning stage 34, adhesive stage 36 and lubricant stage 38 are connected. A pair of ply guides 39 are secured to base 32 for controlling the position of web material 10 passing through processor 16. In the illustrated embodiment ply guides 39 are in generally parallel alignment and are spaced apart by a distance approximately equal to a width of web 10.

Tensioning stage 34 includes a resilient air bag 40 secured to base 32 by a top plate 42, and a pair of side brackets 44. A pneumatic line 46 is coupled to air bag 40 via connector 48 and communicates pressurized air to air bag 40. Pneumatic line 46 may be in fluid communication with an air controller 47, such as an air regulator, capable of altering the air pressure provided to air bag 40. Air controller 47 may be a manually selectable device or may be automatically controlled, such as by an electronic controller. Air controller 47 may be a manual air regulator having a visual air pressure indicator. Air bag 40 is attached at one end to top plate 42 and engages a tensioning plate 50 at its other end. In the illustrated embodiment, tensioning plate 50 extends generally between the pair of guides 39. During operation, tensioning plate 50 reacts to air pressure within air bag 40 and transfers a normal force to web material 10 as a function of air pressure supplied to air bag 40. A web-engaging material 52 is connected to tensioning plate 50 via a clamp 54 coupled to plate 50 by fasteners 55. Material 52 is a wear element and may be replaced as necessary by releasing clamp 54. In the illustrated embodiment, material 52 is a felt fabric element having a thickness of approximately 0.5 inch and being secured to a flexible rubber layer 53 having a thickness of approximately 0.125 inch. Rubber layer element 53 extends at least partially beyond the perimeter of material 52 and wraps partially around a portion of plate 50 to be engaged by clamp 54. A wear plate 56 comprising a wear resistant material, such as stainless steel, engages the base 32 and extends generally between the pair of guides 39. The lateral distance between guides 39 may be between 0.001 to 0.25 inch larger than the lateral width of the web material 10. In one embodiment, the clearance distance between an edge of the web material 10 and guide 39 is approximately 0.125 inch.

Adhesive stage 36 applies a binding agent or adhesive 60 to the web material 10. In the embodiment illustrated in FIG. 1, the adhesive 60 is applied to or within the overlap region 21 of the web material 10. Adhesive 60 may comprise a single-component adhesive, a multi-component adhesive, a single-component cohesive, or a multi-component cohesive. Adhesive stage 36 includes a valve 62 and slot extruder 64, such as manufactured by Valco, Inc. Valve 62 and slot extruder 64 are coupled to base 32 by a pair of side brackets 66 and top slide 68. Slot extruder 64 may be adjusted into a desired lateral position along top slide 68 and side brackets 66. Slot extruder 64 comprises a pair of opposed plates separated a predetermined distance by a shim or set of shims. A gap is cut in the shim or shim set such that a slot as wide as the gap and as long as the thickness of the shim(s) is present between the opposed plates. The adhesive 60 is disposed onto the web material 10 from the slot. Adhesive 60 is conveyed to slot extruder 64 via valve 62 and adhesive conduit 70. Valve 62 is pneumatically controlled via air line 72 so that adhesive 60 flows through valve 62 upon air pressure within air line 72 exceeding a particular value.

Air line 72 may be in fluid communication with an air source (not shown). The delivery of pressurized air within air line 72 may be controlled by an electronic controller or microprocessor serving as an adhesive applicator control device 73. In one embodiment, pressurized air is provided to valve 62 only after a time delay from a start of web material 10 passing through web processor 16. Such a time delay of air to valve 62 results in a time-delayed application of adhesive 60 to web material 10. Occurrences of adhesive 60 puddling may be minimized by such a delayed application of adhesive 60 to web material 10. A time delay of between about 0 to 20 seconds may be useful. A particularly useful time delay is approximately 2 seconds. Initiation of a starting process may be communicated to or within control device 73 by a signal such as provided by a limit switch, pressure switch, proximity switch, optical sensor, etc. Those of ordinary skill in the art will appreciate various approaches to controlling the delivery of adhesive 60 to the surface of web material 10 including alternative methods of providing a time delayed application of the adhesive 60 to the web material 10 as it is drawn through web processor 16, such as during a starting procedure.

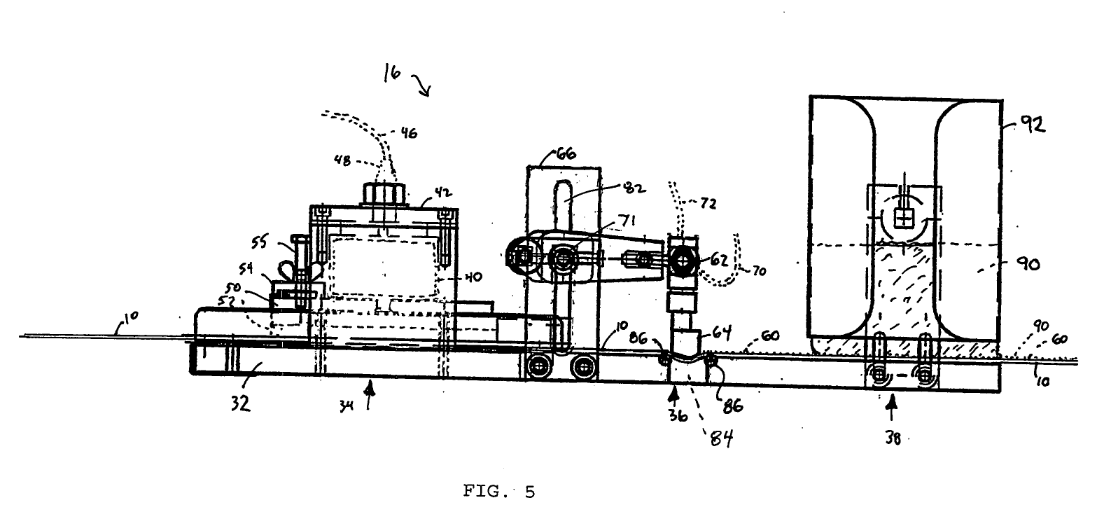

The lateral position of valve 62 and slot extruder 64 within processor 16 may be adjusted by wheel assembly 74 which moves valve 62 and slot extruder 64 along top slide 68. Wheel assembly 74 includes a wheel 76 held within body 78 secured to top slide 68 by a set fastener 80. Wheel assembly 74 rotates a threaded shaft 81 which moves valve 62 and slot extruder 64 toward one side bracket 66 or another depending on the direction of wheel 76 rotation. The vertical position of valve 61 and slot extruder 64 relative to base 32 may be adjusted by loosening threaded fasteners 71 and sliding valve 61 and slot extruder 64 and top slide 66 into position within a range defined by elongated slots 82 in side brackets 66. Fasteners 71 can then be tightened to secure the valve 61 and slot extruder 64 into position. FIG. 2 illustrates the slot extruder 64 disposed at an upper limit of slots 82, while FIG. 5 illustrates the slot extruder 64 disposed in contact with web material 10.

An elongated recess 84 within base 32 is associated with adhesive stage 34. In the illustrated embodiment, recess 84 is defined as an elongated hole through base 32. In other embodiments, recess 84 may be a depression or closed cavity on base 32. A pair of wear bars 86 are provided along elongated edges of recess 84 to minimize abrasive wear caused by the web material 10 moving through processor 16. The web material 10 is engaged and deflected by the slot extruder 64 such that the deposited film of adhesive 60 is maintained at a desired film thickness and such that a generally uniform thickness adhesive layer is deposited on overlap region 21 of the web 10. As illustrated in FIG. 5, slot extruder 64 engages and deflects web material 10 at least partially into recess 84.

As illustrated in FIG. 1, the web material 10 is routed from the processor 16 to the mandrel 24. The web material 10 is wound about the mandrel 24. The mandrel 24 may be stationary, or the mandrel 24 may be capable of rotating about the winding axis of the tube by supporting the mandrel 24 with rolling element bearings or bushing material. A rotating mandrel may be freely turning or may be driven.

Processor 16 of the illustrated embodiment of the present invention includes a lubrication stage 38. Lubricant 90 may be applied to at least a portion of the inner surface 22 of the web material 10 to reduce the friction between the web material and the mandrel 24 during winding operations. Preferably lubricant 90 is not applied to the overlap region 21 to which adhesive 60 is applied. A lubricant holder 92 is coupled to base 32 via brackets 94, 96. Lubricant 90 is provided in block form and is held within lubricant holder 92. One suitable lubricant 90 is CERELUBE lubricant manufactured by Stevenson-Cooper, Inc., of Philadelphia, Pa. CERELUBE lubricant has been used as a lubricant and anti-friction agent by manufacturers of spiral wound tubes, cores, cans, and spindles. In typical applications, CERELUBE lubricant is applied as the paper is drawn over or under a cake of CERELUBE lubricant. The amount applied depends upon the pressure at application, which can be controlled by the operator, or by the various formulations of CERELUBE lubricant. Numerous waxes or other lubricants are known to those of ordinary skill in the art to be suitable for use with paperboard.

The wound core, or tube 20 may be cut to a desired length by using a mechanical core cutter 30 or a servo core cutter (not shown). Alternatively, the wound core 20 may be wound until the supply of web material 10 is depleted. Either the mechanical core cutter or the servo core cutter may traverse a path parallel to the mandrel 24 while bringing a cutting blade into contact with the tube 20. The mechanical cutter comprises a knife type blade and the blade rotates freely about a center axis. The servo cutter comprises a drive motor to actively rotate the cutting blade against the tube 20. Both mechanical and servo cutter are known in the art.

In operation, web material 10 is passed through web processor 16 and wound onto mandrel 24 to form tube 20. Web processor 16 provides a consistent and controllable tension to web material 10 as it is drawn by driven belt 26 onto mandrel 24. The tension may be controlled via tensioning stage 34 by adjusting the air pressure communicated to air bag 40. For example, an increase in air pressure at air bag 40 results in an increase in tension as air bag 40 generates an increased normal force applied to web material 10 resulting in increased friction between web material 10, web-engaging material 52 and wear plate 56. Air pressure applied to air bag 40 may be controlled by air controller 47. The air pressure applied to the air bag 40 may be between 1 to 30 pounds per square inch (psi). More preferably, the applied air pressure may be between 5 to 7 psi. Web material 10 tension may also be adjusted by selecting a different material for web-engaging material 52 or another wear plate 56 having a different surface finish. The tension may also be controlled, to an extent, by adjusting the contact that slot extruder 62 makes with web material 10. As previously described, during a start process of web material 10 passing through web processor 16, the application of adhesive 60 to web material 10 can be time delayed so as to minimize occurrences of adhesive puddling on the surface of web material 10.

As disclosed herein, the present invention can provide a consistent and controllable tension to web material during tube forming processes. The present invention provides a simplified process for forming paperboard tubes, including both single ply and multiple ply tubes.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A multistage web processor comprising:
a tensioning stage applying a first normal force upon a surface of a web material, said tensioning stage including an air bag expanding in response to pressurized air to generate the normal force; and
a gluing stage having an adhesive applicator providing an adhesive across a portion of the web material surface, said gluing stage applying a second normal force to the web material, together the tensioning stage and said gluing stage providing a controlled tension to the web material as the web material is drawn through the apparatus and wrapped around a tube-forming mandrel.

2. The multistage web processor of claim 1 further comprising a lubrication stage applying a lubricant to the web material surface, wherein the gluing stage is located between the lubrication stage and the tensioning stage.

3. The multistage web processor of claim 2 wherein the lubrication stage includes a dry lubricant block held upon a base and wherein the web material is drawn between the dry lubricant and the base.

4. The multistage web processor of claim 1 further comprising a base connecting the pneumatic bag and the adhesive applicator and an air controller in communication with the pneumatic bag.

5. The multistage web processor of claim 4 further comprising a pair of guides for directing the web material through at least a portion of the base.

6. The multistage web processor of claim 4 wherein the base includes a recess within the gluing stage and wherein the web material is biased by the adhesive application at least partially into the aperture.

7. The multistage web processor of claim 6 wherein the adhesive applicator is a slot extruder in contact with the surface of the web material and configured to apply adhesive to an edge of said web material in a longitudinal strip.

8. The multistage web processor of claim 4 wherein the tensioning stage includes a tensioning plate connected to the pneumatic bag and a wear plate connected to the base and wherein the web material passes between said tensioning plate and the wear plate, tension thereby being generated in the web material by friction arising between the web material, the tensioning plate and the wear plate.

9. The multistage web processor of claim 8 further comprising a felt material secured to the tensioning plate and engaging the surface of the web material between at least a portion of the tensioning plate and the base.

10. A web processor comprising:
an air bag receiving pressurized air and expanding to generate a frictional force between a web material and a portion of the web processor; and
an adhesive applicator providing an adhesive along a portion of the web material, said frictional force providing a tension to the web material being drawn through the web processor as the tubular core is formed.

11. The web processor of claim 10 wherein the air bag is connected to a plate which engages the web material surface.

12. The web processor of claim 11 further comprising a base, and wherein the web material passes between said plate and the base.

13. The web processor of claim 12 further comprising a felt material secured to the plate and engaging the surface of the web material between at least a portion of the plate and the base.

14. The web processor of claim 12 further comprising a pair of guides for directing the web material along at least a portion of the base.

15. The web processor of claim 12 wherein the base includes a recess within and wherein the web material is biased by the adhesive applicator at least partially into the recess.

16. The web processor of claim 10 wherein the adhesive applicator is a slot extruder in contact with the surface of the web material.

17. The web processor of claim 10 further comprising a lubricator applying a lubricant to the web material surface.

18. The web processor of claim 17 wherein the lubricator includes a dry lubricant block held upon a base and wherein the web material is drawn between the dry lubricant and the base.

19. The web processor of claim 10 further comprising an air controller capable of altering air pressure delivered to the air bag.

20. The web processor of claim 19, wherein air pressure provided to the air bag is generally constant and provided within a range of 1 to 10 psi.

21. The web processor of claim 20, wherein air pressure provided to the air bag is between approximately 5-7 psi.

22. The web processor of claim 10 further comprising an adhesive applicator control device.

23. The web processor of claim 22 wherein the adhesive applicator control device provides for a delayed application of adhesive to the web material during a starting process.

24. The web processor of claim 23 wherein application of adhesive to the web material is delayed from about 0.001 to 20 seconds.

25. The web processor of claim 24 wherein application of adhesive to the web material is delayed approximately 2 seconds from initial start of web material passing through web processor

26. A method of forming a core from a web material with a web processor, said method comprising the steps of:
withdrawing a web material from a supply roll;
passing the web of material through a tensioning stage having an air bag providing a normal force to a surface of the web material;
passing the web material through an adhesive stage having an adhesive applicator applying an adhesive to a portion of the web material; and
winding the web material upon a mandrel whereby the adhesive-applied portion of web material overlaps another portion of the web material to form a core.

27. The method of claim 26 wherein a tension level of the web existing between the tensioning stage and the mandrel is adjustable as a function of air pressure communicated to the air bag.

28. The method of claim 26 wherein the adhesive applicator engages and deflects the web resulting in a second normal force being applied to the web material.

29. The method of claim 26 wherein adhesive application is time-delayed relative to a start of web material passing through the web processor.

30. The method of claim 26 further comprising the step of:
lubricating the web material prior to the step of winding the web material upon the mandrel to form the core.

31. The method of claim 30 wherein the step of lubricating includes engaging the surface of web material with a block of dry lubricant and transferring some of the dry lubricant to the surface.

32. A method of forming a core from a web material with a web processor, said method comprising the steps of:
withdrawing a web material from a supply roll;
drawing the web material through the web processor prior to being wound upon a mandrel to form a tubular core;
communicating an air pressure to an air bag within the web processor, said air bag compressing the drawn web material against a surface within the web processor developing a friction force between the web material and the surface and resulting in a tension applied to the drawn web material;
applying an adhesive to a portion of the web material; and
winding the web material upon a mandrel whereby the adhesive-applied portion of web material overlaps another portion of the web material to form the tubular core.

33. The method of claim 32 wherein a tension level is adjustable as a function of air pressure communicated to the air bag.

34. The method of claim 32 wherein an adhesive applicator engages and deflects the web material resulting in a second normal force being applied to the web material.

35. The method of claim 32 wherein adhesive application is time-delayed relative to a start of web material moving through the web processor.

36. The method of claim 32 further comprising the step of:
lubricating the web material prior to the step of winding the web material upon the mandrel to form the core.

37. The method of claim 36 wherein the step of lubricating includes engaging the surface of web material with a block of dry lubricant and transferring some of the dry lubricant to the surface.
